(19) United States
(12) Patent Application Publication
(10) Pub. No.: US 2026/0272019 A1
(43) Pub. Date: Sep. 17, 2026

(54) CERAMIC HEATING MEMBER

(71) Applicant: Philip Morris Products S.A., Neuchatel (CH)

(72) Inventors: Jérôme Christian COURBAT, Cortaillod (CH); Leander DITTMANN, Crissier (CH); Ross Peter JONES, Cambridge (GB)

(73) Assignee: Philip Morris Products S.A., Neuchatel (CH)

(21) Appl. No.: 19/168,715

(22) PCT Filed: Mar. 28, 2024
(86) PCT No.: PCT/EP2024/058644

§ 371 Date: Sep. 24, 2025

(30) Foreign Application Priority Data
Mar. 29, 2023 (EP) 23165213.2

(51) Int. Cl. A24F 40/46; A24F 40/10; A24F 40/44; A24F 40/48; A24F 40/70; C04B 35/622; C04B 41/00; C04B 41/45; H05B 3/26

(52) U.S. Cl. CPC A24F 40/46; A24F 40/10; A24F 40/44; A24F 40/48; A24F 40/70; C04B 35/622; C04B 41/0072; C04B 41/4535; C04B 41/4564; H05B 3/265; H05B 2203/017; H05B 2203/021

(57) ABSTRACT

A ceramic heating member for an aerosol-generating system is provided, the ceramic heating member including: a heating portion configured to vaporise a liquid aerosol-forming substrate; and a porous portion configured to convey the liquid aerosol-forming substrate to the heating portion, the heating portion and the porous portion being integrally formed. A method of manufacturing the ceramic heating member is also provided, the method including: forming a porous ceramic body for conveying a liquid aerosol-forming substrate; and doping a portion of the porous ceramic body to form a heating portion for vaporising the liquid aerosol-generating substrate.

The present disclosure relates to a heating member for an aerosol-generating system. In particular, but not exclusively, the present disclosure relates to a heating member for a handheld electrically operated aerosol-generating system for heating an aerosol-forming substrate to generate an aerosol and for delivering the aerosol into the mouth of a user. The present disclosure further relates to a cartridge and an aerosol-generating system comprising the heating member and also to method of manufacturing a heating member.

Aerosol-generating systems that heat a liquid aerosol-forming substrate in order to generate an aerosol for delivery to a user are generally known in the prior art. These systems typically comprise an aerosol-generating device and a replaceable cartridge. The cartridge includes a liquid aerosol-forming substrate that is capable of releasing volatile compounds when heated. The cartridge typically also includes a heater for heating the liquid aerosol-forming substrate. In known aerosol-generating systems, the heater comprises a resistive heating element wound around a wick that supplies liquid aerosol-forming substrate to the heating element. The aerosol-generating device or cartridge also comprises a mouthpiece. When a user takes a puff on the mouthpiece, an electric current is passed through the heating element causing it to be heated by resistive or Joule heating, which, in turn, heats the liquid aerosol-forming substrate supplied by the wick. This causes volatile compounds to be released from the liquid aerosol-forming substrate that cool to form an aerosol. The aerosol is then drawn into a user's mouth via the mouthpiece.

In some other known aerosol-generating systems, the aerosol-generating system comprises a heater assembly having a resistive heating element located on a heating surface of a porous body. Liquid aerosol-forming substrate is supplied from a liquid storage portion to the heating element via the pores of the porous body by capillary action. Such known aerosol-generating systems have a number of drawbacks. For example, they can be difficult to manufacture with consistent manufacturing tolerances which can result in inconsistent vapour production and flavour generation. Inconsistent manufacturing tolerances can also affect the transfer of heat from the heating element to the wick reducing the energy efficiencies of such devices. A further problem encountered by such known aerosol-generating systems is “dry heating” or a “dry puff”, which arises when the heating element is heated with insufficient liquid aerosol-forming substrate being supplied to the heating element. This can occur, for example, when a user has consumed all of the liquid aerosol-forming substrate in the cartridge such that the cartridge is depleted of liquid aerosol-forming substrate and needs replacing. During operation, it is preferable to maintain a supply of liquid aerosol-forming substrate to the heating element such that the heating element is maintained in a wet state because this helps to ensure that a satisfactory aerosol is produced when a negative pressure is applied at the mouthpiece. Dry heating can result in overheating of the heating element and, potentially, thermal decomposition of the liquid aerosol-forming substrate, which can produce undesirable by-products and an unsatisfactory aerosol. Allowing the aerosol-generating system to continue to operate when liquid aerosol-forming substrate is not being supplied to the heating element can result in a poor user experience.

A number of prior art documents disclose aerosol-generating systems having a porous transport element and a separate heating element, both of which are assembled within the aerosol-generating system such that the heating element, to which power is supplied through electrical contacts, heats the porous transport element. Such known systems can be difficult to manufacture and assemble with consistent manufacturing tolerances which can result in inconsistent vapour production and flavour generation. Inconsistent manufacturing tolerances can also affect the transfer of heat from the heating element to the porous transport element reducing the energy efficiencies of such systems. Liquid is supplied from a liquid reservoir to the heating element via pores within the transport element. This known aerosol-generating system may also experience a “dry heating” or “dry puff” situation, and as such has the associated disadvantages, namely undesirable by-products, an unsatisfactory aerosol, and a poor user experience.

It would be desirable to provide a heating member which is easier to reliably manufacture, thus resulting in a more energy efficient heater assembly capable of generating a more consistent aerosol. It would be desirable to provide a heating member that reduces the likelihood of a user experiencing dry heating or a dry puff.

The present disclosure relates to a ceramic heating member for an aerosol-generating system. The ceramic heating member may comprise a heating portion for vaporising a liquid aerosol-forming substrate. The ceramic heating member may comprise a porous portion for conveying the liquid aerosol-forming substrate to the heating portion. The heating portion and the porous portion may be integrally formed.

According to the present invention, there is provided a ceramic heating member for an aerosol-generating system. The ceramic heating member comprises a heating portion for vaporising a liquid aerosol-forming substrate. The ceramic heating member comprises a porous portion for conveying the liquid aerosol-forming substrate to the heating portion. The heating portion and the porous portion are integrally formed.

As used herein, the term “aerosol-generating device” relates to a device that interacts with a liquid aerosol-forming substrate to generate an aerosol.

As used herein, the term “aerosol-generating cartridge” relates to a component that interacts with a liquid aerosol-forming device to generate an aerosol. An aerosol-generating cartridge contains, or is configured to contain, a liquid aerosol-generating substrate.

As used herein, the term “liquid aerosol-generating substrate” relates to a liquid substrate capable of releasing volatile compounds that can form an aerosol. Such volatile compounds can be released by heating the aerosol-forming substrate.

As used herein, the term “heating element” refers to a component which transfers heat energy to the liquid aerosol-generating substrate. It will be appreciated that the electrical heating element may be deposited directly on the porous body.

As used herein, the term “electrical parameter” refers to an electrical property or characteristic, including but not being limited to, a voltage or potential difference, an electric current or an electrical resistance. The electrical parameter can be monitored by measuring the parameter directly such as a voltage or can be determined indirectly from another electrical parameter or parameters. For example, an electrical resistance can be determined using Ohm's Law by firstly determining a voltage across a component and an electric current through the component and dividing the voltage by the current.

As used herein, the term “porous body” refers to a component which has a plurality of pores, at least some of which are interconnected. The porous body is configured to contain liquid within the plurality of pores.

As used herein, the term “thermally insulating” refers to a property in which heat transfer is reduced or restricted. A more thermally insulating component will transfer less heat, via conduction, convection or radiation, than a more thermally insulating component.

The ceramic heating member of the present invention provides an improved component for an aerosol-generating system. By providing a ceramic heating member in which a heating portion, for vaporising a liquid aerosol-forming substrate, and a porous portion, for conveying the liquid aerosol-forming substrate, are integrally formed, a more robust and reliable connection can be established between the heating portion and the porous portion. This may advantageously help to improve the transfer of heat between the heating portion and the porous portion.

Forming the heating portion integrally with the porous portion may also advantageously provide a heating member which is easier to reliably manufacture, thus resulting in a more energy efficient heating member capable of generating a more consistent aerosol. This, in turn, may provide a user of the aerosol-generating system with an improved and more enjoyable experience. Such an arrangement may also help to reduce the likelihood of a user experiencing dry heating or a dry puff.

An advantage of forming the heating portion integrally with the porous portion is that it helps to alleviate the problems of manufacturing tolerances encountered with wick and coil heaters and other arrangements in which a heating element is detached from a liquid transport element. The dimensions and arrangement of the electrical heating portion relative to the porous portion are also fixed, which helps to produce a more consistent aerosol. This is because the electrical heating portion is fixed to the porous portion, which helps to supply liquid aerosol-forming substrate to the heating element. This also helps to prevent unwanted loss of heat, which helps to improve energy efficiency.

By forming the heating portion integrally with the porous portion, the resulting aerosol-generating system may benefit from reduced material requirements. This is because the need for intermediate components which fix the heating portion relative to the porous portion can be reduced or eliminated entirely. The material savings can result in cost savings of the overall aerosol-generating system. An additional advantage of the reduced material requirements in the overall aerosol-generating system is the provision of a more sustainable and environmentally friendly solution.

Such a ceramic heating member may also be advantageous in that the risk of the heating portion and the porous portion becoming detached is greatly reduced.

The heating portion may be fluid permeable.

As used herein, the term “fluid permeable” in the context of the heating portion means that liquid aerosol-forming substrate is able to pass from one side of the heating portion to the other side of the heating portion without needing to go around the heating portion.

It will be understood that for the heating portion to be fluid permeable, the material from which the heating portion is made may be fluid permeable. Alternatively, the material from which the heating portion is made may be fluid impermeable, but the structure or arrangement of the heating portion may nevertheless allow liquid aerosol-forming substrate to pass from one side of the heating portion to the other side of the heating portion.

The heating portion may be an electrical heating portion. For example, the heating portion may be a resistive heating portion. The heating portion may have any suitable shape or form. Examples of suitable shapes and forms include but are not limited to a band, a strip, a filament, a wire, a mesh, a flat spiral coil, fibres or a fabric.

In some preferred examples, the heating portion is planar. The planar heating portion may extend substantially in a plane.

The porous portion may comprise a porous material having open-cell pores. The plurality of open-cell pores may be interconnected to provide a fluid pathway for aerosol-generating liquid through the porous portion. The porous portion may comprise a material which does not chemically interact with the liquid aerosol-forming substrate. The porous material may have a porosity of between 20 percent and 80 percent. The porous portion may have a flat surface or a curved surface. The porous portion may have a geometrical shape. The porous portion may be in the shape of a cube or a cuboid, or it may have a shape of a disc or a cylinder, or a combination of any of these shapes. The porous portion may comprise or consist of a material with a low thermal conductivity. The porous portion may comprise or consist of non-electrically conductive material. The porous portion may comprise a polymeric or a ceramic material. The porous portion may comprise cotton. The porous portion may comprise porous ceramic, such as but not limited to Al₂O₃, ZrO₂, Si₃N₄, SiC, Ti₃AlC₂, BN, AlN, SiO₂, MgO, mica, diatomite, silicates, silicides, borides, glass, or a combination of any of these materials. The porous portion may comprise aluminium nitride or silicon carbide. Aluminium nitride and silicon carbide typically have a relatively high thermal conductivity, of approximately 100-200 Watts per metre-Kelvin. In a sintered form, aluminium nitride and silicon carbide can have a thermal conductivity of less than 100 Watts per metre-Kelvin.

In some preferred examples, the heating portion comprises a mesh. The heating portion may comprise an array of filaments forming a mesh. As used herein the term “mesh” encompasses grids and arrays of filaments having spaces therebetween. The term mesh also includes woven and non-woven fabrics.

The filaments may be formed by etching a sheet material, such as a foil. This may be particularly advantageous when the heating portion comprises an array of parallel filaments.

If the heating portion comprises a mesh or fabric of filaments, the filaments may be individually formed and knitted together.

According to an example of the present disclosure, there is provided a cartridge. The cartridge may comprise a ceramic heating member. The ceramic heating member may comprise a heating portion for vaporising a liquid aerosol-forming substrate. The ceramic heating member may comprise a porous portion for conveying the liquid aerosol-forming substrate to the heating portion. The heating portion and the porous portion may be integrally formed.

According to an example of the present disclosure, there is provided a cartridge, the cartridge comprising a ceramic heating member for an aerosol-generating system. The ceramic heating member comprises a heating portion for vaporising a liquid aerosol-forming substrate. The ceramic heating member comprises a porous portion for conveying the liquid aerosol-forming substrate to the heating portion. The heating portion and the porous portion are integrally formed.

The cartridge may comprise the liquid aerosol-forming substrate in the liquid storage portion. The liquid aerosol-forming substrate may be as described above.

The porous portion may be fluidly connected to the liquid storage portion. The porous portion may have a liquid absorption surface. The liquid absorption surface of the porous portion may be fluidly connected to the liquid storage portion.

The liquid storage portion may be arranged at the liquid absorption surface of the porous portion.

There is provided an aerosol-generating system. The aerosol-generating system may comprise a cartridge and an aerosol-generating device. The cartridge may comprise a heating member. The cartridge may comprise a liquid storage portion for holding an aerosol-forming substrate. The heating member may comprise a heating portion for vaporising the liquid aerosol-forming substrate. The heating member may comprise a porous portion for conveying the liquid aerosol-forming substrate to the heating portion. The porous portion may have a liquid absorption surface and a heating end. The heating portion may be located at the heating end of the porous portion.

The aerosol-generating device may comprise a power supply for supplying electrical power to the heating portion. The aerosol-generating device may comprise control circuitry configured to control a supply of power from the power supply to the heating portion.

There is provided an aerosol-generating system comprising: a cartridge and an aerosol-generating device, the cartridge comprising a heating member and a liquid storage portion for holding a liquid aerosol-forming substrate, the heating member comprising: a heating portion for vaporising the liquid aerosol-forming substrate; a porous portion for conveying the liquid aerosol-forming substrate to the heating portion. The porous portion has a liquid absorption surface and a heating end. The heating portion is located at the heating end of the porous portion.

The aerosol-generating device may comprise a power supply for supplying electrical power to the heating portion; and control circuitry configured to control a supply of power from the power supply to the heating portion.

The cartridge may comprise the liquid aerosol-forming substrate in the liquid storage portion. The liquid aerosol-forming substrate may be as described above.

The aerosol-generating system may be portable. The aerosol-generating system may have a size comparable to a conventional cigar or cigarette.

The cartridge may be removably couplable to the aerosol-generating device.

The aerosol-forming substrate may be liquid at room temperature. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol-former. The aerosol-former may be glycerine or propylene glycol. The aerosol former may comprise both glycerine and propylene glycol. The liquid aerosol-forming substrate may have a nicotine concentration of between about 0.5% and about 10%, for example about 2%.

The airflow pathway may pass through the liquid storage portion. For example, the liquid storage portion may have an annular cross-section defining an internal passage or aerosol channel, and the airflow pathway may extend through the internal passage or aerosol channel of the liquid storage portion.

The cartridge may comprise a cartridge housing. The cartridge housing may be formed from a durable material. The cartridge housing may be formed from a liquid impermeable material. The cartridge housing may be formed form a mouldable plastics material, such as polypropylene (PP) or polyethylene terephthalate (PET) or a copolymer such as Tritan™, which is made from three monomers: dimethyl terephthalate (DMT), cyclohexanedimethanol (CHDM), and 2,2,4,4-tetramethyl-1,3-cyclobutanediol (CBDO). The cartridge housing may define a portion of the liquid storage portion or reservoir. The cartridge housing may define the liquid storage portion. The cartridge housing and the liquid storage portion may be integrally formed. Alternatively, the liquid storage portion may be formed separately from the outer housing and arranged in the outer housing.

The aerosol-generating device may comprise a power supply for supplying power to the heating member. The aerosol-generating device may comprise control circuitry for controlling the supply of power from the power supply to the heating member. The cartridge may be removably couplable to the aerosol-generating device.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The aerosol-generating device housing may define a cavity for receiving a portion of a cartridge. The aerosol-generating device may have a connection end configured to connect the aerosol-generating device to a cartridge. The connection end may comprise the cavity for receiving the cartridge.

The power supply may be any suitable power supply. Preferably, the power supply is a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences of the aerosol-generating system; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the aerosol-generating system.

The control circuitry may comprise any suitable controller or electrical components. The controller may comprise a memory. Information for performing a method of operation of the device or system may be stored in the memory. The control circuitry may comprise a microprocessor. The microprocessor may be a programmable microprocessor, a microcontroller, or an application specific integrated chip (ASIC) or other electronic circuitry capable of providing control. The control circuitry may be configured to supply power to the heating member continuously following activation of the device, or may be configured to supply power intermittently, such as on a puff-by-puff basis. The power may be supplied to the heating member in the form of pulses of electrical current, for example, by means of pulse width modulation (PWM).

Features described in relation to one of the above examples may equally be applied to other examples of the present disclosure.

The porous portion may comprise a liquid absorption surface and a heating end. The heating portion may be adjacent to the heating end of the porous portion. The heating end of the porous portion may comprise an interface with the heating portion. The interface between the porous portion and the heating portion may not be a well-defined interface, such that the material properties of the interface may transition from the material properties of the heating portion to the material properties of the porous portion. In other words, an end of the interface adjacent the heating portion may have substantially the same material properties as the heating portion and an end of the interface adjacent the porous portion may substantially the same material properties as the porous portion.

The porous portion may have any thickness. The thickness of the porous portion may refer to the extension of the porous portion in a direction between the liquid absorption surface and the heating end. This may correspond to the direction of the liquid flow path through the porous portion. The porous portion may have a thickness which depends on the thermal properties of the material it is made from and the liquid it contains. The porous portion may have a thickness of at least 1 millimetre. For example, the porous portion may have a thickness of at least 2 millimetres, at least 3 millimetres, at least 4 millimetres, or at least 5 millimetres.

The porous portion may have a thickness of no more than 10 millimetres. For example, the porous portion may have a thickness of no more than 9 millimetres, no more than 8 millimetres, no more than 7 millimetres, or no more than 6 millimetres.

The porous portion may have a thickness of between 1 millimetre and 10 millimetres. For example, the porous portion may have a thickness of between 2 millimetres and 9 millimetres, between 3 millimetres and 8 millimetres, between 4 millimetres and 7 millimetres, or between 5 millimetres and 6 millimetres. The porous portion may have a thickness of about 5 millimetres.

The heating portion may have any thickness. The thickness of the heating portion may refer to the extension of the heating portion in a direction between a liquid absorption end of the heating portion adjacent the heating end of the porous portion and a heating surface of the heating portion. This may correspond to the direction of the liquid flow path through the porous portion. The heating portion may have a thickness of at least 1 micrometre. The heating portion may have a thickness of at least 2 micrometres. The heating portion may have a thickness of at least 5 micrometres. The heating portion may have a thickness of at least 200 micrometres. The heating portion may have a thickness of at least 220 micrometres.

The heating portion may have a thickness of less than 300 micrometres. The heating portion may have a thickness of less than 250 micrometres. The heating portion may have a thickness of less than 50 micrometres. The heating portion may have a thickness of less than 20 micrometres.

The heating portion may have a thickness of between 1 millimetre and 10 millimetres. The heating portion may have a thickness of between 1 millimetre and 5 millimetres. The heating portion may have a thickness of between 2 millimetres and 5 millimetres. The heating portion may have a thickness of between 200 micrometre and 300 micrometres. The heating portion may have a thickness of between 200 micrometres and 250 micrometres. The heating portion may have a thickness of between 220 micrometres and 300 micrometres.

The heating portion may be porous. The heating porous may be porous across the entire surface of the heating portion. Alternatively, the heating portion may not be porous across the entire surface of the heating portion. For example, a first portion of the heating portion may be porous and a second portion of the heating portion may be non-porous. Embodiments in which the heating portion is a porous heating portion may be advantageous in that the aerosol-generating liquid may flow from the porous portion into the heating element. This may improve energy efficiency of aerosol-generation and may also help with the generation of a more consistent aerosol.

The heating element may be a doped ceramic material. The heating element may be doped such that the heating element is electrically conductive. Doping the ceramic material may be advantageous in that it avoids altering the porosity of ceramic material when it is a porous ceramic material. This is can be preferable to other known techniques of forming a heating element, which involve depositing the heating element by thin film or thick film techniques, which can reduce the properties of the ceramic material, in particular the porosity. The thickness of the doped portion may be increased where the cross sectional area of the heating portion is smaller or where the heating resistance required is higher. The dopant used to dope the ceramic heating member may be an n-type dopant or a p-type dopant. The dopant may be any one of, but not limited to, nitrogen, phosphorous, aluminium or boron. The interface between the heating portion and the porous portion may comprise a portion of partially doped ceramic material. In other words, an end of the interface adjacent the heating portion may be doped to substantially the same extent as the heating portion and an end of the interface adjacent the porous portion may be substantially undoped.

The ceramic material may be doped by ion implantation. Ion implantation involves the implantation of ions into a layer of bulk material or the exchange of ions, taking one species out and replacing it by another. Ion implantation can be carried out chemically or physically.

The ceramic material may be doped by transmutation. Transmutation changes one species of atom already present in the material into another by irradiation with particles, such as neutrons or alpha particles, which leads to a short lived decay process leading to a stable isotope which was not present in the original material. Transmutation is advantageous in that the doping occurs directly in the ceramic material and does not require the bonding or attachment of an additional electrically conductive material. Transmutation therefore provides a more monolithic approach.

The heating portion may comprise an electrically conductive material. The heating portion may comprise an electrically resistive heating portion. The heating portion may be made from any suitable electrically conductive material. Suitable materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, constantan, nickel-, cobalt-, chromium-, aluminum-, titanium-, zirconium-, hafnium-, niobium-, molybdenum-, tantalum-, tungsten-, tin-, gallium-, manganese-and iron-containing alloys, and super-alloys based on nickel, iron, cobalt, stainless steel, Timetal®, iron-aluminum based alloys and iron-manganese-aluminum based alloys. Timetal® is a registered trade mark of Titanium Metals Corporation. The heating element may be made from stainless steel, for example, a 300 series stainless steel such as AISI 304, 316, 304L, 316L. In a preferred example, the electrical heating element may comprise one of more of NiCr and TiZr.

Additionally, the heating portion may comprise combinations of the above materials. A combination of materials may be used to improve the control of the resistance of the heating element. For example, materials with a high intrinsic resistance may be combined with materials with a low intrinsic resistance. This may be advantageous if one of the materials is more beneficial from other perspectives, for example price, machinability or other physical and chemical parameters. Advantageously, high resistivity heating allow more efficient use of battery energy.

The heating portion and the porous portion may be molded as a single monolithic piece. This may also help to simplify the manufacturing of the ceramic heating member by reducing manufacturing times and providing a more cost effective solution. This advantageously creates a tight mechanical connection between the heating portion and the porous portion.

The heating portion may be a doped portion of the ceramic heating member. The heating portion may be doped such that the heating portion is electrically conductive. Doping the ceramic heating member may be advantageous in that it avoids altering the porosity of ceramic material when it is a porous ceramic material. This is can be preferable to other known techniques of forming a heating element, which involve depositing the heating element by thin film or thick film techniques, which can reduce the properties of the ceramic material, in particular the porosity. The thickness of the doped portion may be increased where the cross sectional area of the heating portion is smaller or where the heating resistance required is higher. The dopant used to dope the ceramic heating member may be an n-type dopant or a p-type dopant. The dopant may be any one of, but not limited to, nitrogen, phosphorous, aluminium or boron. The interface between the heating portion and the porous portion may comprise a portion of partially doped ceramic material. In other words, an end of the interface adjacent the heating portion may be doped to substantially the same extent as the heating portion and an end of the interface adjacent the porous portion may be substantially undoped.

The liquid absorption surface of the porous portion may have an area that is different to an area of the heating end of the porous portion. The porous portion may be substantially incompressible. The porous portion may be incompressible.

A porous portion having a heating end with the same area as the liquid absorption surface may be inefficient due to heat generated by the heater not being used to vaporise an aerosol-forming substrate. An inefficient heating member provides a reduced throughput of aerosol.

Advantageously, providing a porous portion in which the heating end and the liquid absorption surface have different areas may improve the throughput of aerosol that can be generated by the heating member compared to a porous portion in which the heating end has the same area as the liquid absorption surface.

Increasing heating efficiency may reduce power consumption during use of the heating member.

The area of the heating end of the porous portion may be less than the area of the liquid absorption surface of the porous portion. The area of the liquid absorption surface of the porous portion may be greater than the area of the heating end of the porous portion.

Advantageously, when the porous portion has a shape such that the heating end has a smaller area than the liquid absorption surface, heat flow from the heating portion towards the liquid absorption surface and then to the liquid storage portion by conduction may be reduced. The relatively smaller heating end provides a small heat transfer area through which heat can be transferred, by conduction, from the heating portion to the porous portion, and towards the liquid absorption surface.

Decreasing heat loss from the heating portion to the bulk of the porous portion may consequently increase heating efficiency because more of the heat energy provided by the heating portion may be used to vaporise the aerosol-forming substrate. Consequently, the porous portion having a shape such that the heating end has a smaller area than the liquid absorption surface may increase the throughput of aerosol generated by the heating member.

Advantageously, the porous portion having a shape such that the heating end has a smaller area than the liquid absorption surface may reduce the area of the heating end that is not close enough to the heating portion to allow aerosol-forming substrate being conveyed to the heating end to be vaporised. In other words, the size and shape of the heating end may more closely match with the size and shape of the heating portion. Consequently, more of the liquid aerosol-forming substrate may be conveyed from the liquid absorption surface to an area of the heating end that is near to the heating portion, which may result in more of the liquid aerosol-forming substrate at the heating end being vaporised. More liquid aerosol-forming substrate being vaporised may increase the throughput of aerosol generated by the heating member. Further, this arrangement may allow for the power density at the heating end to be maximised, which also improves heating efficiency.

Advantageously, the liquid absorption surface having a larger area than the heating end may allow the liquid absorption surface to receive a larger volume of liquid aerosol-substrate from a liquid storage portion. As a consequence of the relatively smaller area of the heating end, as the liquid aerosol-forming substrate is conveyed through the porous portion and towards the heating end, the flow rate of the liquid aerosol-forming substrate to the heating portion may be higher than with a typical heating member. A higher flow rate of liquid aerosol-forming substrate at the heating portion may increase the throughput of aerosol generated by the heating member.

The area of the heating end of the porous body may be greater than the area of the liquid absorption surface of the ceramic porous body. The area of the liquid absorption surface of the porous body may be less than the area of the heating end of the porous portion.

Advantageously, when the porous portion has a shape such that the liquid absorption surface has a smaller area than the heating end, the smaller area of the liquid absorption surface may cause a reduction in heat flow through the aerosol-forming substrate from the heating portion to the liquid absorption surface via heat conduction. Reducing heat flow from the heating end to the liquid absorption surface may consequently increase thermal efficiency because more of the heat energy provided by the heating portion may be used to vaporise the liquid aerosol-forming substrate. Consequently, the porous portion having a shape such that the liquid absorption surface has a smaller area than the heating end may provide for increased heating efficiency, which may increase the throughput of aerosol generated by the heating member.

Advantageously, the porous portion having a shape such that the liquid absorption surface has a smaller area than the heating end may reduce the area of the heating end that is not close enough to the heating portion to allow aerosol-forming substrate being conveyed to the heating end to be vaporised. In other words, the size and shape of the heating end may more closely match with the size and shape of the heating portion. Consequently, more of the liquid aerosol-forming substrate being may be conveyed from the liquid absorption surface and to an area of the heating end that is near to the heating portion, which may result in more of the liquid aerosol-forming substrate at the heating end being vaporised. More liquid aerosol-forming substrate being vaporised may increase the throughput of aerosol generated by the heating member.

The heating end of the porous portion may be convex in one or both of a first transverse direction and a second transverse direction, the first transverse direction being orthogonal to the second transverse direction.

Inclusion of such a porous portion may enable the surface area of the heating end to be increased without increasing a width of the heating end. This may increase the efficiency of the aerosol-generating system at vaporising liquid aerosol-forming substrate, whilst helping to avoid the need to redesign other components of the aerosol-generating system to accommodate the porous portion.

The provision of a heating end that is convex along one or both of a first transverse direction and a second transverse direction may help to avoid or minimise recirculation of airflow adjacent the heater assembly. In particular, a heating end that is convex may help to avoid or minimise recirculation of airflow adjacent to a central region of the heater assembly. This may reduce a level of turbulence in the airflow adjacent to the heater assembly. Reducing a level of turbulence in the airflow adjacent to the heater assembly may improve the entrainment of vapour of aerosol-forming substrate in the airflow. This may improve the quality of the aerosol generated by the aerosol-generating system.

Improving the entrainment of vapour in the airflow through the aerosol-generating system may avoid or reduce vapour condensing to form large droplets of liquid aerosol-forming substrate. This may help to avoid an unpleasant and undesirable user experience.

Improving the entrainment of vapour in the airflow through the aerosol-generating system may avoid or reduce vapour condensing on internal surfaces of the aerosol-generating system. This may help to avoid or minimise damage to the aerosol-generating system and may allow optimal function of the aerosol-generating system.

The heating end of the porous portion may be convex in a single transverse direction.

The heating end of the porous portion may be convex in both the first transverse direction and the second transverse direction.

The heating end of the porous portion may be convex in one or both of the first transverse direction and the second transverse direction based on the configuration of the heater assembly relative to one or more airflow pathways of the aerosol-generating system. The heater assembly may be configured to minimise a level of turbulence in the airflow adjacent to the heater assembly. For example, it may be advantageous for the heater assembly to be arranged in the aerosol-generating system such that air drawn into the aerosol-generating system follows a curved path along at least a portion of a curved surface of the heater assembly.

The heating element may be convex in one or both of the first transverse direction and the second transverse direction.

The curvature of the heating element in the first transverse direction may be substantially the same as the curvature of the heating end of the porous portion in the first transverse direction. The curvature of the heating element in the second transverse direction may be substantially the same as the curvature of the heating end of the porous body in the second transverse direction. The curvature of the heating element in both the first transverse direction and the second transverse direction may be substantially the same as the curvature of the heating end of the porous body in both the first transverse direction and the second transverse direction, respectively.

The average pore size of the porous portion may vary between the liquid absorption surface and the heating end.

The porous portion may include a first average pore size at the liquid absorption surface, and a second average pore size at the heating end. The first average pore size may be greater than the second average pore size.

The first pore size at the liquid absorption surface may be about 150 micrometres. The second pore size at the heating end may be about 20 micrometres. The pore size may vary linearly between the first pore size and the second pore size to provide a pore size gradient between the liquid absorption surface and the heating end of the porous ceramic body.

The pore structure and pore size gradient in the porous ceramic body may be achieved by etching the pores into a portion of silicon carbide.

The ceramic heating member may be configured to be supplied with a power varying from a high power to a low power over the duration of a puff. The ceramic heating member may be comprised by an aerosol-generating system comprising a control system configured to supply the ceramic heating element with a power varying from a high power to a low power over the duration of a puff. By varying the power in this way, it may help to shorten the time needed for the aerosol-generating substrate to reach the boiling point and become aerosolized. An initial high power may help to compensate for the thermal inertia of the overall heating system and results in a higher volume of aerosol being generated during a puff. The initial high power at the start of a puff is advantageous in helping to ensure that the aerosol-generating system is able to generate aerosol quickly after a puff is detected by a user of the system. A high power in the beginning of the puff ensures that the heating portion reaches its operating temperature quickly. This also ensures that the time to evaporation of the aerosol-generating substrate is shorter than the time of heat conduction in the aerosol-generating system. This results in reduced thermal losses in the system. Over the course of a puff the power supplied is reduced so as to only provide heat to incoming liquid and to maintain the heating portion at the operating temperature.

The ceramic heating member may be configured to be supplied with a short burst of high power at the start of a puff, followed by a longer supply of lower power.

The ceramic heating member may be configured to be supplied with a power varying from a high power to a low power in more than two steps over the duration of a puff.

The ceramic heating member may be configured to be supplied with a power which reduces as a function of time over the duration of a puff.

According to an example of the present disclosure, there is provided an aerosol-generating system. The aerosol-generating system may comprise a heating member as discussed above. The heating element may be fluid permeable such that, in use, vapour is emitted from the heating member in an average vapour emission direction. The aerosol-generating system may further comprise an air inlet and an aerosol outlet. The air inlet may be in fluid communication with the aerosol outlet to define an airflow pathway through the aerosol-generating system. The heating member may be arranged in fluid communication with the airflow pathway such that air flows past the heating member in an average airflow direction. The heating member and airflow pathway may be arranged such that an angle between the average vapour emission direction and the average airflow direction is less than 135 degrees.

Advantageously, by arranging the heating member and airflow pathway such that the angle between the average vapour emission direction and the average airflow direction is less than 135 degrees, the average airflow direction does not directly oppose the average vapour emission direction. Therefore, the momentum of the vapour and the airflow is not reduced to the same extent as when the average airflow direction does directly oppose the average vapour emission direction. This reduces the tendency for recirculation and turbulence to occur in the airflow path and the vapour is less likely to impinge on the internal surfaces of the aerosol-generating system. Accordingly, condensation of aerosol within the aerosol-generating system is less likely to occur.

The average vapour emission direction may be substantially perpendicular to the heating surface of the porous ceramic body. As used herein, the term “substantially perpendicular” means 90 degrees plus or minus 10 degrees, preferably plus or minus 5 degrees.

An advantage of the average vapour emission direction being substantially perpendicular to the heating surface of the porous ceramic body is that it makes orientating the average vapour emission direction relative to the average airflow direction straightforward because the vapour will be emitted substantially perpendicular to the heating surface of the of the porous ceramic body. Therefore, by angling the heating member appropriately relative to the airflow in the airflow pathway or vice versa, a desired angle between the average vapour emission direction and average airflow direction can be achieved.

The heating member and airflow pathway may be arranged such that an angle between the average vapour emission direction and the average airflow direction is less than 110 degrees, preferably less than 100 degrees.

The heating member and airflow pathway may be arranged such that an angle between the average vapour emission direction and the average airflow direction is approximately 90 degrees. This arrangement results in the vapour being emitted at an angle substantially perpendicular to the average airflow direction. The average vapour emission direction has no speed or direction component that opposes the airflow direction and therefore any loss of momentum of the airflow is reduced. This reduces the tendency for recirculation and turbulence to occur in the airflow path and the vapour is less likely to impinge on the internal surfaces of the aerosol-generating system. Furthermore, entrainment of the vapour in the airflow is improved. Accordingly, condensation of aerosol within the aerosol-generating system is less likely to occur.

The heating member and airflow pathway may be arranged such that an angle between the average vapour emission direction and the average airflow direction is less than 90 degrees. In this arrangement, the average vapour emission direction has no speed or direction component that opposes the airflow direction and actually has a speed and direction component in the same direction as the average airflow direction. Therefore, any loss of momentum of the airflow is further reduced. This reduces the tendency for recirculation and turbulence to occur in the airflow path and the vapour is less likely to impinge on the internal surfaces of the aerosol-generating system. Furthermore, entrainment of the vapour in the airflow is improved. Accordingly, condensation of aerosol within the aerosol-generating system is less likely to occur.

The heating member and airflow pathway may be arranged such that an angle between the average vapour emission direction and the average airflow direction is approximately 45 degrees. The heating member and airflow pathway may be arranged such that an angle between the average vapour emission direction and the average airflow direction is less than 45 degrees.

The heating member and airflow pathway may be arranged such that the average vapour emission direction and the average airflow direction are substantially the same. In this arrangement, there is virtually no loss of momentum of the airflow as the average vapour emission direction and average airflow direction are the same. This reduces the tendency for recirculation and turbulence to occur in the airflow path and the vapour is less likely to impinge on the internal surfaces of the aerosol-generating system. Furthermore, entrainment of the vapour in the airflow is improved. Accordingly, condensation of aerosol within the aerosol-generating system is less likely to occur.

A cross-sectional area of the airflow pathway in the region of the heating member may be configured such that, in use, the airflow speed is between 0.1 and 2 metres per second, preferably between 0.5 and 1.5 metres per second and more preferably approximately 1 metre per second. This range of airflow speeds has been found to effectively entrain the vapour emitted from different designs of heating element without excessively cooling the heating element.

The heating element may comprise a porous layer of electrically conductive material. Advantageously, a heating element comprising a porous layer of electrically conductive material allows an electrical current to flow through the heating element such that the heating element can be resistively heated and also allows vapours to travel through the heating element via the pores in its porous structure. Thus vapour emission occurs through the porous heating element. This avoids the build-up of vapour pressure underneath the heating element and high speed vapour emission at the sides of the heating element. The inventors have found that this arrangement produces a consistent vapour across the heating element and a lower vapour emission speed of approximately 0.1 metres per second. Such a low vapour emission speed means that the vapour is easily carried away by the airflow reducing the impingement of vapour on the internal walls of the aerosol-generating system.

The present disclosure also relates to a method of manufacturing a ceramic heating member for an aerosol-generating system. The method may comprise the step of forming a porous ceramic body for conveying a liquid aerosol-forming substrate. The method may further comprise the step of doping a portion of the porous ceramic body to form a heating portion for vaporising the liquid aerosol-generating substrate.

According to the present invention, there is also provided a further method of manufacturing a ceramic heating member for an aerosol-generating system. The method comprises the step of forming a porous ceramic body for conveying a liquid aerosol-forming substrate. The method further comprises the step of doping a portion of the porous ceramic body to form a heating portion for vaporising the liquid aerosol-generating substrate.

The step of doping a portion of the porous ceramic body may comprise applying a dopant material to the porous ceramic body. The step of doping a portion of the porous ceramic body may comprise heating the dopant material and the porous ceramic body to diffuse dopant ions into the porous ceramic body.

The step of doping a portion of the porous ceramic body may comprise bringing the porous ceramic body into contact with a liquid containing a dopant material. The step of doping a portion of the porous ceramic body may comprise heating the dopant material and the porous ceramic body. The step of doping a portion of the porous ceramic body may comprise applying an electrical field to diffuse dopant ions into the porous ceramic body.

The step of doping a portion of the porous ceramic body may comprise ion implantation. Ion implantation involves the implantation of ions into a layer of bulk material or the exchange of ions, taking one species out and replacing it by another. Ion implantation can be carried out chemically or physically.

The step of doping a portion of the porous ceramic body may comprise transmutation. Transmutation changes one species of atom already present in the material into another by irradiation with particles, such as neutrons or alpha particles, which leads to a short lived decay process leading to a stable isotope which was not present in the original material. Transmutation is advantageous in that the doping occurs directly in the ceramic material and does not require the bonding or attachment of an additional electrically conductive material. Transmutation therefore provides a more monolithic approach.

The present disclosure also relates to a further method of manufacturing a ceramic heating member for an aerosol-generating system. The method may comprise the step of placing a layer of a first ceramic material in a mold. The method may further comprise the step of placing a layer of a second ceramic material in the mold. The method may further comprise the step of molding the layer of first ceramic material and the layer of second ceramic material in the mold to form a ceramic heating member comprising a heating portion formed from the layer of first ceramic material and a porous portion formed from the layer of second ceramic material.

According to the present invention, there is also provided a further method of manufacturing a ceramic heating member for an aerosol-generating system. The method comprises the step of placing a layer of a first ceramic material in a mold. The method further comprises the step of placing a layer of a second ceramic material in the mold. The method further comprises the step of molding the layer of first ceramic material and the layer of second ceramic material in the mold to form a ceramic heating member comprising a heating portion formed from the layer of first ceramic material and a porous portion formed from the layer of second ceramic material.

The step of placing a layer of a second ceramic material in the mold may comprise placing the second ceramic material directly adjacent to the first ceramic material.

The first ceramic material may be an electrically conductive material. The second ceramic material may be an electrically insulating layer.

Features described above in relation to the heating element of the present disclosure and their associated advantages may equally be applied to the method of the present disclosure.

Below, there is provided a non-exhaustive list of non-limiting examples. Any one or more of the features of these examples may be combined with any one or more features of another example, embodiment, or aspect described herein.

EX1. A ceramic heating member for an aerosol-generating system, the ceramic heating member comprising: a heating portion for vaporising a liquid aerosol-forming substrate; and a porous portion for conveying the liquid aerosol-forming substrate to the heating portion, wherein the heating portion and the porous portion are integrally formed.

EX2. A ceramic heating member according to EX1, wherein the porous portion comprises a liquid absorption surface and a heating end, and wherein the heating portion is adjacent to the heating end of the porous portion.

EX3. A ceramic heating member according to EX1 or EX2, wherein the heating portion is porous.

EX4. A ceramic heating member according to any one of EX1 to EX3, wherein the heating portion comprises an electrically conductive material.

EX5. A ceramic heating member according to any one of EX1 to EX4, wherein the heating portion and the porous portion are molded as a single monolithic piece.

EX6. A ceramic heating member according to any one of EX1 to EX4, wherein the heating portion is a doped portion of the ceramic heating member.

EX7. A ceramic heating member according to any one of EX2 to EX6, wherein the liquid absorption surface of the porous portion has an area that is different to an area of the heating end of the porous portion.

EX8. A ceramic heating member according to any one of EX2 to EX7, wherein the heating end of the porous body is convex in one or both of a first transverse direction and a second transverse direction, the first transverse direction being orthogonal to the second transverse direction.

EX9. A ceramic heating member according to any one of EX2 to EX8, wherein the average pore size of the porous portion varies between the liquid absorption surface and the heating end.

EX 10. A ceramic heating member according to any one of EX 1 to EX 9, wherein the ceramic heating member is configured to be supplied with a power varying from a high power to a low power over the duration of a puff.

EX11. A ceramic heating member according to EX10, wherein the ceramic heating member is configured to be supplied with a short burst of high power at the start of a puff, followed by a longer supply of lower power.

EX12. A ceramic heating member according to EX10, wherein the ceramic heating member is configured to be supplied with a power varying from a high power to a low power in more than two steps over the duration of a puff.

EX13. A ceramic heating member according to claim EX10, wherein the ceramic heating member is configured to be supplied with a power which reduces as a function of time over the duration of a puff.

EX14. An aerosol-generating system comprising the ceramic heating member of any of EX1 to EX13, wherein the heating element is fluid permeable such that, in use, vapour is emitted from the heater assembly in an average vapour emission direction; wherein the aerosol-generating system further comprises an air inlet and an aerosol outlet, the air inlet being in fluid communication with the aerosol outlet to define an airflow pathway through the aerosol-generating system; wherein the heater assembly is arranged in fluid communication with the airflow pathway such that air flows past the heater assembly in an average airflow direction, wherein the heater assembly and airflow pathway are arranged such that an angle between the average vapour emission direction and the average airflow direction is less than 135 degrees.

EX15. A method of manufacturing a ceramic heating member for an aerosol-generating system, the method comprising: forming a porous ceramic body for conveying a liquid aerosol-forming substrate, doping a portion of the porous ceramic body to form a heating portion for vaporising the liquid aerosol-generating substrate.

EX16. A method of manufacturing a ceramic heating member according to EX15, wherein the step of doping a portion of the porous ceramic body comprises: applying a dopant material to the porous ceramic body; and heating the dopant material and the porous ceramic body to diffuse dopant ions into the porous ceramic body.

EX17. A method of manufacturing a ceramic heating member according to EX15, wherein the step of doping a portion of the porous ceramic body comprises: bringing the porous ceramic body into contact with a liquid containing a dopant material; heating the dopant material and the porous ceramic body; and applying an electrical field to diffuse dopant ions into the porous ceramic body.

EX18. A method of manufacturing a ceramic heating member according to EX15, wherein the step of doping a portion of the porous ceramic body comprises ion implantation.

EX19. A method of manufacturing a ceramic heating member according to EX15, wherein the step of doping a portion of the porous ceramic body comprises transmutation.

EX20. A method of manufacturing a ceramic heating member for an aerosol-generating system, the method comprising: placing a layer of a first ceramic material in a mold; placing a layer of a second ceramic material in the mold; and molding the layer of first ceramic material and the layer of second ceramic material in the mold to form a ceramic heating member comprising a heating portion formed from the layer of first ceramic material and a porous portion formed from the layer of second ceramic material.

The invention will now be further described, by way of example only, with reference to the accompanying drawings in which:

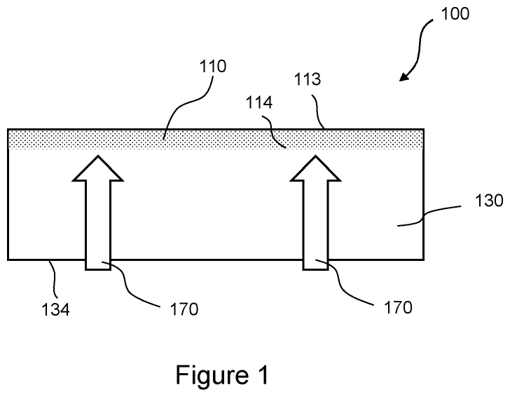

FIG. 1 shows a schematic illustration of a cross-section through a ceramic heating member in accordance with an example of the present disclosure, in which a heating portion and a porous portion are integrally formed.

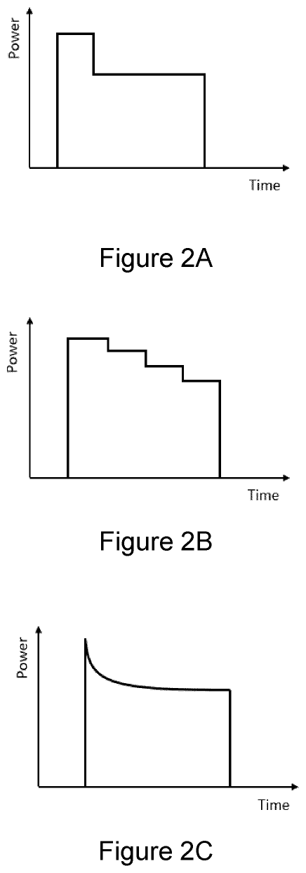

FIGS. 2A, 2B and 2C show the power profiled of three different modes of energy supply to the heating portion.

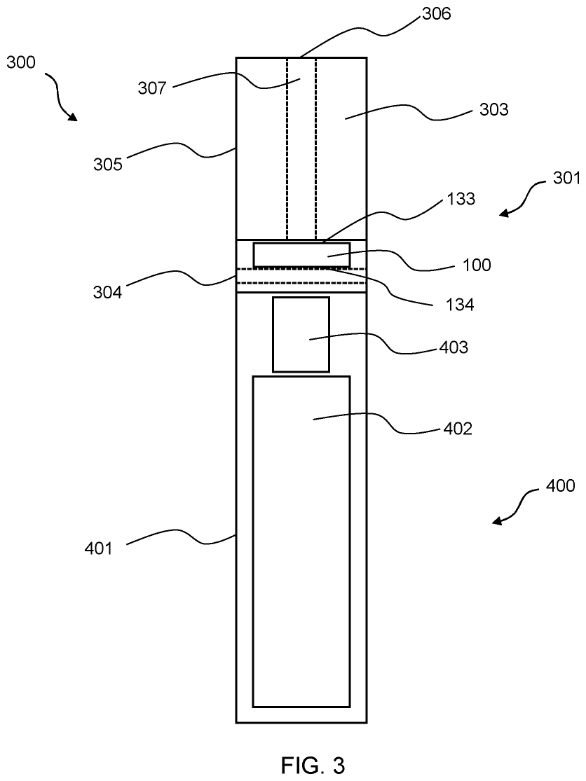

FIG. 3 is a schematic illustration of the interior of an aerosol-generating system according to an example of the present disclosure.

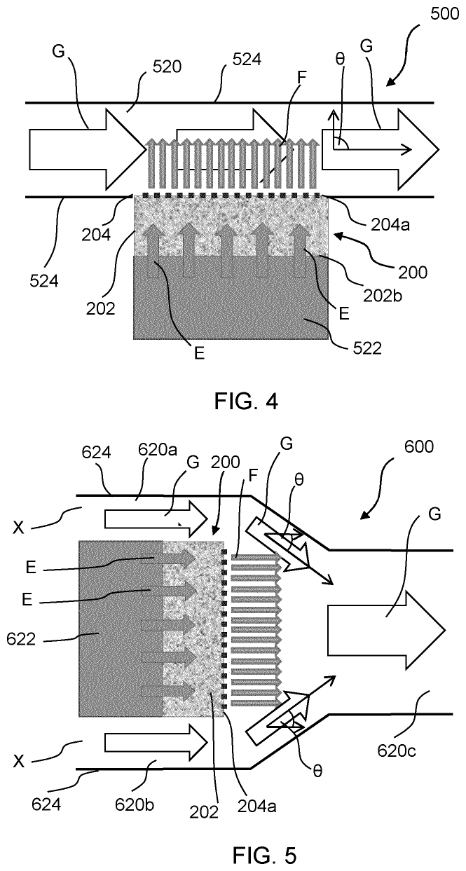

FIG. 4 is a schematic cross-sectional view of part of an aerosol-generating system according to another example of the present disclosure showing an arrangement of a heating member relative to an airflow pathway within the aerosol-generating system.

FIG. 5 is a schematic cross-sectional view of part of an aerosol-generating system according to another example of the present disclosure showing another arrangement of a heating member relative to an airflow pathway within the aerosol-generating system.

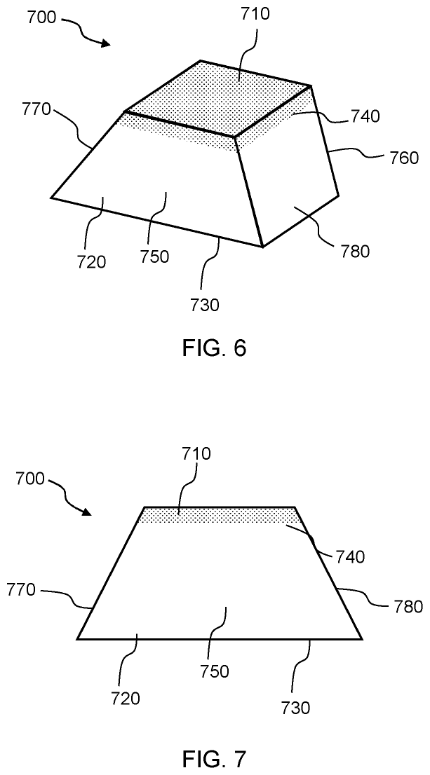

FIGS. 6 and 7 show a schematic illustration of an example of a heating member for an aerosol-generating system.

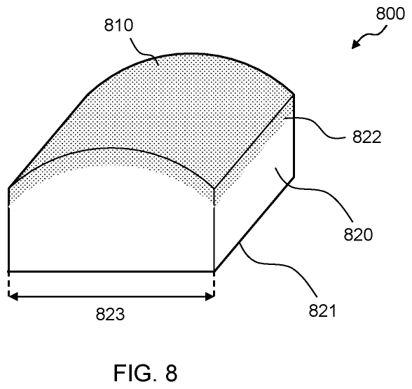

FIG. 8 shows a heating member for use in an aerosol-generating system.

Embodiments of the invention will now be described in detail, by way of example only, with reference to the accompanying drawings, in which:

Embodiments of the invention will now be described in detail, by way of example only, with reference to the accompanying drawings, in which:

FIG. 1 shows a schematic illustration of a cross-section through a ceramic heating member 100 in accordance with an example of the present disclosure, in which a heating portion 110 and a porous portion 130 are integrally formed. Referring to FIG. 1, the ceramic heating member 100 comprises: a heating portion 110, a porous portion 130, and electrical control circuitry (not shown for clarity).

The porous portion 130 is configured to supply liquid aerosol-forming substrate to the heating portion 110. Specifically, the porous portion 130 is configured to transmit liquid aerosol-forming substrate from a liquid reservoir (not shown in FIG. 1 for clarity) to the heating portion 110. The porous portion 130 is configured to store some liquid aerosol-forming substrate before aerosolization by the heating portion 110.

In this example embodiment, the ceramic heating member 100 is a cylindrical block. The porous portion 130 has a first end and an opposing second end. The first end has an end face which is a liquid absorption surface 134 and the second end, which is a heating end has an interface 114 with the heating portion. In this example, the liquid absorption surface 134 is a substantially flat surface. The heating portion has a first end and an opposing second end. The first end has an end face which is a heating surface 113, and the second end which is a liquid absorption end has an interface 114 with the porous portion. The ceramic heating member 100 also has a lateral face extending between the liquid absorption surface 134 and the heating surface 113. The ceramic heating member 100 has a thickness defined between the liquid absorption surface 134 and the heating surface 113.

The porous portion 130 comprises a plurality open-cell pores. The plurality of open-cell pores are interconnected to provide a fluid pathway for aerosol-generating liquid through the porous portion 130.

The open pores are longitudinal pores which generally extend from the liquid absorption surface 134 to the interface 114 of the porous portion 130 with the heating portion 110. The pore size of the pores in the porous ceramic body 130 vary between the liquid absorption surface 134 and the heating surface 133.

The porous portion 130 includes a heating end and a liquid absorption end, the heating surface being disposed at the heating end, and the liquid absorption surface 134 being disposed at the liquid absorption end. The porous ceramic body includes a first average pore size at the liquid absorption end, and a second average pore size at the heating end. The first average pore size is greater than the second average pore size.

The first pore size at the liquid absorption end is about 150 micrometres. The second pore size at the heating end is about 20 micrometres. The pore size varies linearly between the first pore size and the second pore size to provide a pore size gradient between the liquid absorption end and the heating end of the porous portion 130.

The pore structure and pore size gradient in the porous portion 130 is achieved by etching the pores into a portion of silicon carbide.

The ceramic heating member 100 may be configured such that liquid can pass through the fluid pathway of the porous portion 130 to the heating portion 110, as depicted by arrows 170. The porous portion 130 is configured for fluid 170 to pass from the liquid absorption surface 134 to the interface 114 with the heating portion. The ceramic heating member 100 comprises a material which does not chemically interact with the liquid aerosol-forming substrate. The ceramic heating member 100 comprises porous ceramic, such as but not limited to one or more of: Al2O3, ZrO2, Si3N4, SIC, Ti3AlC2, BN, AlN, SiO2, MgO, mica, diatomite, silicates, silicides, borides, glass. It will be appreciated that the ceramic heating member 100 may have a different shape or comprise a different material.

The heating portion 110 is configured to heat a liquid aerosol-forming substrate to form an aerosol. The heating portion 110 is configured to convert electrical energy into heat energy by material resistance of the heating portion 110 to an electrical current. The heating portion 110 is a doped portion of the ceramic heating member. In other words, the heating portion has been doped to make it electrically conductive.

In this example embodiment. the heating portion 110 is a porous heating portion.

The interface 114 between the porous portion and the heating portion may not be a well-defined interface, such that the material properties of the interface 114 may transition from the material properties of the heating portion 110 to the material properties of the porous portion 130. In other words, the interface 114 between the heating portion 110 and the porous portion 130 comprises a portion of partially doped ceramic material. In other words, an end of the interface 114 adjacent the heating portion 110 is doped to substantially the same extent as the heating portion 110 and an end of the interface 114 adjacent the porous portion 130 is substantially undoped. Thus, the regions illustrated in the figures are schematic in nature and their shapes are not intended to illustrate the actual shape of a region of the ceramic heating member and are not intended to limit the scope of this disclosure.

FIGS. 2A, 2B and 2C show the power profiles of three different modes of energy supply to the ceramic heating member. These profiles show the power supplied to the ceramic heating member over time. In these power profiles, power varies from a high power to a low power over the duration of a puff. In each of FIGS. 2A, 2B and 2C, an initial burst of high power is supplied to the ceramic heating member. Over the course of a puff the power supplied is reduced so as to only provide heat to incoming liquid and to maintain the heating portion at the operating temperature.

As shown in the power profile of FIG. 2A, the ceramic heating member is configured to be supplied with a short burst of high power at the start of a puff, followed by a longer supply of lower power.

As shown in FIG. 2B, the ceramic heating member is configured to be supplied with a power varying from a high power to a low power in more than two steps over the duration of a puff.

As shown in FIG. 2C, the ceramic heating member is configured to be supplied with a power which reduces as a function of time over the duration of a puff.

FIG. 3 is a schematic illustration of the interior of an aerosol-generating system 300 according to an example of the present disclosure. The aerosol-generating system 300 comprises two main components, a cartridge 301 and a main body part or aerosol-generating device 400. The cartridge 301 is removably connected to the aerosol-generating device 400. The aerosol-generating device 400 comprises a device housing 301 that contains a power supply in the form of a battery 402, which in this example is a rechargeable lithium ion battery, and control circuitry 403. The aerosol-generating system 300 is portable and has a size comparable to a conventional cigar or cigarette. A mouthpiece is arranged at a mouth end of the cartridge 301.

The cartridge 301 comprises a cartridge housing containing a heating member 100 and a liquid reservoir or liquid storage portion 303 for holding a liquid aerosol-forming substrate. Liquid aerosol-forming substrate is conveyed downwards from the liquid absorption surface 134 through the porous portion to the heating portion and vaporised aerosol-forming substrate is emitted from the heating surface 133 of the heating member when electrical power is supplied to the heating portion.

The cartridge 301 comprises one or more air inlets 304 formed in the cartridge housing 305 at a location along the length of the cartridge 301. An aerosol outlet 306 is located in the mouthpiece at the mouth end of the cartridge 301. The one or more air inlets 304 are in fluid communication with the aerosol outlet 306 to define an airflow pathway through the cartridge 301 of the aerosol-generating system 300. The airflow pathway flows from the one or more air inlets 304 to the heating member 100 in an airflow channel. The heating member 100 is arranged in fluid communication with the airflow pathway in the airflow channel. Air enters the one or more air inlets 304 and flows through the airflow channel past the heating member 100 in an average airflow direction.

In the example of FIG. 3, the liquid storage portion 303 is annular in cross-section and is arranged around a central sealed aerosol channel 307. Once the airflow pathway reaches the heating member 100, it is diverted upwards around the sides of the heating member 100 and flows through the aerosol channel 307 to the aerosol outlet 306.

The aerosol-generating system 300 is configured so that a user can puff or draw on the mouthpiece of the cartridge to draw aerosol into their mouth through the aerosol outlet 306. In operation, when a user puffs on the mouthpiece, air is drawn in through the one or more air inlets 304, along the airflow pathway through the airflow channel, past and around the heating member 100 and along the airflow pathway through the aerosol channel 307 to the aerosol outlet 306. The control circuitry 403 controls the supply of electrical power from the battery 402 to the cartridge 301 when the system is activated. This in turn controls the amount and properties of the vapour produced by the heating member 100. The control circuitry 403 includes an airflow sensor (not shown) and supplies electrical power to the heating member 100 when user puffs are detected by the airflow sensor. This type of control arrangement is well established in aerosol-generating systems such as inhalers and e-cigarettes. When a user puffs on the mouthpiece of the cartridge 301, the heating member 100 is activated and generates a vapour that is entrained in the airflow pathway. The vapour cools within the airflow pathway to form an aerosol, which is then drawn into the user's mouth through the aerosol outlet 306.

FIG. 4 is a schematic cross-sectional view of part of an aerosol-generating system 500 according to another example of the present disclosure showing an arrangement of a heating member 200 relative to an airflow pathway 520 within the aerosol-generating system 500. For simplicity, other components of the aerosol-generating system have been omitted from FIG. 4. The heating member 200 of FIG. 4 is identical to the heating members of FIGS. 1 and 2. The aerosol-generating system 500 comprises a liquid storage portion 522 that holds a liquid aerosol-forming substrate in contact with the liquid absorption surface 202b of the porous portion 202. Liquid aerosol-forming substrate is conveyed from the liquid storage portion 522 through the porous portion 202 to the heating surface 204a of the heating portion 204, as indicated by arrows E. Vaporised aerosol-forming substrate is emitted through the porous heating portion 204 from the heating surface 204a. As indicated by arrows F, the average vapour emission direction is substantially perpendicular to the heating surface 204a of the heating portion 204.

In the example of FIG. 4, the heating member 200 is arranged below or to one side of the airflow channel or pathway 520, which airflow pathway 520 is defined by airflow channel walls 524. As viewed in FIG. 4, a left-hand end of the visible portion of the airflow pathway 520 receives airflow from an air inlet (not shown) and the right-hand end of the visible portion of the airflow pathway delivers airflow to an aerosol outlet (not shown). The heating surface 204a of the heating portion 204 is arranged parallel to the airflow pathway 520 and faces into the airflow pathway 520. The heating member 200 is in fluid communication with the airflow pathway such that the airflow in the airflow pathway flows past the heating member 200 in an average airflow direction, as indicated by arrows G. The heating member 200 and airflow pathway 520 are arranged such that an angle 0 between the average vapour emission direction F and the average airflow direction G is approximately 90 degrees, that is, at an angle e substantially perpendicular to the average airflow direction G. The average vapour emission direction F has no speed or direction component that opposes the average airflow direction G and therefore any loss of momentum of the airflow is reduced. This reduces the tendency for recirculation and turbulence to occur in the airflow path 520 and the vapour is less likely to impinge on the internal surfaces of the airflow channel walls 524.

FIG. 5 is a schematic cross-sectional view of part of an aerosol-generating system 600 according to another example of the present disclosure showing another arrangement of a heating member 200 relative to an airflow pathway 620 within the aerosol-generating system 600. For simplicity, other components of the aerosol-generating system have been omitted from FIG. 6. The heating member 200 of FIG. 6 is identical to the heater assemblies 200 of FIGS. 2 and 3. The aerosol-generating system 600 comprises a liquid storage portion 622 that holds a liquid aerosol-forming substrate in contact with the liquid absorption surface 202b of the porous portion 202. Liquid aerosol-forming substrate is conveyed from the liquid storage portion 622 through the porous portion 202 and the heating portion 204 to the heating surface 204a, as indicated by arrows E. Vaporised aerosol-forming substrate is emitted through the porous heating portion 204 from the heating surface 204a. As indicated by arrows F, the average vapour emission direction is substantially perpendicular to the heating surface 204a of the heating portion 204.

In the example of FIG. 5, the airflow channel or pathway 620 is split into first and second airflow pathway sections 620a and 620b which pass either side of the heating member 200. The first and second airflow pathway sections 620a and 620b combine downstream of the heating member 200 into a third airflow pathway section 620c. The first and second airflow pathway sections 620a and 620b receive airflow from one or more air inlets (not shown) and the third airflow pathway section 620c delivers airflow to an aerosol outlet (not shown). The airflow pathway 620 is defined by airflow channel walls 624. The heating surface 202a of the porous body 202 is arranged substantially perpendicular to the airflow pathway 620 and faces in a downstream direction of the airflow pathway 620. The heating member 200 is in fluid communication with the airflow pathway such that the airflow in the airflow pathway flows past the heating member 200 in an average airflow direction, as indicated by arrows G.

The heating member 200 and airflow pathway 220 are arranged such that an angle 0 between the average vapour emission direction F and the average airflow direction G is less than 90 degrees. Upstream of the heating surface 204a of the heating portion 204, the average airflow direction G past the heating member 200 is substantially the same as the vapour emission direction F. At the point along the airflow pathway 620 corresponding to the heating surface 204a the airflow pathway 620 starts to narrow or taper inwards, at which point the average airflow direction G past the heating member 200 changes to an angle 0 relative to the vapour emission direction F of approximately 45 degrees. Downstream of the heating surface 204a of the heating portion 204 in the third airflow pathway section 620c, the average airflow direction G of the combined airflow is again substantially the same as the vapour emission direction F. It will be appreciated that the narrowing or tapering of the airflow pathway 620 could be omitted. In which case, the average airflow direction G past the heating member 100 would be substantially the same as the vapour emission direction F.

FIGS. 6 and 7 show a schematic illustration of an example of a heating member 700 for an aerosol-generating system. The heating member includes a heating portion 710 and a porous portion 720.

The heating portion 710 is configured to vaporise an aerosol-forming substrate, such as a liquid aerosol-forming substrate, to form an aerosol. The heating portion 710 is configured to convert electrical energy into heat energy by material resistance of the heating portion 710 to an electrical current. In this example embodiment, the heating portion 710 is in direct contact with the porous portion 720.

The porous portion 720 is configured to convey the liquid aerosol-forming substrate to the heating portion 710. In other words, the porous portion 720 supplies the liquid aerosol-forming substrate to the heating portion 710.

The porous portion 720 has a first end face and an opposing second end. The first end face is a liquid absorption surface 730 and the second end is a heating end 740. In this example, the liquid absorption surface 730 and the heating end 740 are both substantially flat. The porous portion 720 also has a plurality of lateral faces extending between the liquid absorption surface 730 and the heating end 740.

In this example, as will be discussed in more detail below, the porous portion 720 has a first lateral face 750 opposing a second lateral face 760, and a third lateral face 770 opposing a fourth lateral face 780.

The porous portion 720 comprises a plurality of pores. The plurality of pores are interconnected to provide a fluid pathway for liquid aerosol-forming substrate through the porous portion 720, from the liquid absorption surface 730 to the heating end 740. The porous portion 720 is formed from a material that does not chemically interact with the liquid aerosol-forming substrate. In this example, the porous portion 720 is a porous portion and may be formed from, for example, Ca₂SiO₃ or SiO₂ (or Ca₂SiO₃ and SiO₂).

The heating portion 710 is formed integrally with the porous portion 720. In the example of FIGS. 6 and 7, the heating portion 710 is a doped portion of the heating member.

The liquid absorption surface 730 of the porous portion 720 has an area that is different to an area of the heating end 740 of the porous portion 720. Specifically, in the example of FIGS. 6 and 7, the area of the heating end 740 is less than the area of the liquid absorption surface 730.

In the example of FIGS. 6 and 7, the heating end 740 has smaller area than the liquid absorption surface 730 because the length of the heating end 740 is less than the length of the liquid absorption surface 730. In addition, or alternatively, in another example, the heating end 740 may have a smaller area than the liquid absorption surface 730 because the width of the heating end 740 is less than the width of the liquid absorption surface 730.

In the example of FIGS. 6 and 7, the porous portion 720 is shaped as a trapezoid prism. With the porous portion 720 having a trapezoid prism shape, the first lateral face 750 and the second lateral face 760 both have a trapezium shape, specifically an isosceles trapezoid, the third lateral face 770 and the fourth lateral face 780 both have a rectangle shape, and the liquid absorption surface 730 and the heating end 740 both have a rectangle shape. In another example, the liquid absorption surface 730 and the heating end 740 may have a square shape.

The porous portion 720 tapers from the liquid absorption surface 730 towards the heating end 740. In other words, the cross-sectional area of the porous portion 720 gradually becomes smaller from the liquid absorption surface 730 towards the heating end 740. In the example of FIGS. 6 and 7, the length of the porous portion 720 decreases from the liquid absorption surface 730 towards the heating end 740 which causes the tapering.

FIG. 8 shows a heating member 800 for use in an aerosol-generating system. The heating member 800 comprises a heating portion 810 for vaporising a liquid aerosol-forming substrate. The heating member 800 also comprises a porous portion 820 for conveying the liquid aerosol-forming substrate to the heating portion 810. The porous portion 820 has a liquid absorption surface 821 and an opposed heating end 822. The heating portion 810 is located on the heating end 822 of the porous portion 820. The porous portion 820 can be made from any suitable ceramic material such as the materials discussed in any of the examples above.

The heating end 822 of the porous portion 820 is curved. In particular, the heating end 822 of the porous portion 820 is convexly curved in a single transverse direction (the first transverse direction).

The porous portion 820 is prismatic in shape. When viewing a longitudinal cross-section perpendicular to the direction of curvature of the porous portion 820, the heating end 822 of the porous portion 820 is shown as an arc. The porous portion 820 has two longitudinal planes of symmetry.

The heating end 822 of the porous portion 820 has a width 823 in the first transverse direction substantially the same as the width of the porous portion 820 in the first transverse direction, and substantially the same as the width of the heating member 800 in the first transverse direction. The heating end 820 of the porous portion 820 has a width of about 5 millimetres in the first transverse direction.

The heating end 822 of the porous portion has a of curvature of about 3.6 millimetres. The heating end 822 of the porous portion has a surface area of about 28 square millimetres.

The porous portion 820 comprises four longitudinal surfaces or side walls extending from the liquid absorption surface 821 to the heating end 822. The four side walls are substantially perpendicular to the liquid absorption surface 821, which is substantially flat. The liquid absorption surface 821 is square in shape.

The heating portion 810 is a resistive heating portion 810 and is curved. In particular, the curvature of the heating portion 810 is substantially the same as the curvature of the heating end 822 of the porous portion 820. As such, the heating portion 810 is also convexly curved in a single transverse direction.

The heating portion 810 is located directly on the heating end 822 of the porous portion 820. The heating portion 810 extends across a majority of the heating end 822 of the porous portion 820. Substantially the entirety of the heating portion 810 is in contact with the heating end 822 of the porous portion 820.

1.-15. (canceled)

16. A ceramic heating member for an aerosol-generating system, the ceramic heating member comprising:
a heating portion configured to vaporise a liquid aerosol-forming substrate; and
a porous portion configured to convey the liquid aerosol-forming substrate to the heating portion,
wherein the heating portion and the porous portion are integrally formed.

17. The ceramic heating member according to claim 16, wherein the heating portion is planar.

18. The ceramic heating member according to claim 16,
wherein the porous portion comprises a liquid absorption surface and a heating end, and
wherein the heating portion is adjacent to the heating end of the porous portion.

19. The ceramic heating member according to claim 18, wherein the liquid absorption surface is opposite the heating end.

20. The ceramic heating member according to claim 16, wherein the heating portion is porous.

21. The ceramic heating member according to claim 16, wherein the heating portion comprises an electrically conductive material.

22. The ceramic heating member according to claim 16, wherein the heating portion and the porous portion are molded as a single monolithic piece.

23. The ceramic heating member according to claim 16, wherein the heating portion is a doped portion of the ceramic heating member.

24. The ceramic heating member according to claim 18, wherein the liquid absorption surface of the porous portion has an area that is different from an area of the heating end of the porous portion.

25. The ceramic heating member according to claim 18, wherein the heating end of the porous body is convex in one or both of a first transverse direction and a second transverse direction, the first transverse direction being orthogonal to the second transverse direction.

26. An aerosol-generating system, comprising:
the ceramic heating member according to claim 16,
wherein the heating portion is fluid-permeable such that vapour is emitted from the heating portion in an average vapour emission direction; and
an air inlet and an aerosol outlet, the air inlet being in fluid communication with the aerosol outlet to define an airflow pathway through the aerosol-generating system,
wherein the heating portion is arranged in fluid communication with the airflow pathway such that air flows past the heating portion in an average airflow direction, and
wherein the heating portion and airflow pathway are arranged such that an angle between the average vapour emission direction and the average airflow direction is less than 135 degrees.

27. A method of manufacturing a ceramic heating member for an aerosol-generating system, the method comprising:
forming a porous ceramic body for conveying a liquid aerosol-forming substrate; and
doping a portion of the porous ceramic body to form a heating portion for vaporising the liquid aerosol-generating substrate.

28. The method according to claim 27, wherein the step of doping a portion of the porous ceramic body comprises:
applying a dopant material to the porous ceramic body; and
heating the dopant material and the porous ceramic body to diffuse dopant ions into the porous ceramic body.

29. The method according to claim 27, wherein the step of doping a portion of the porous ceramic body comprises:
bringing the porous ceramic body into contact with a liquid containing a dopant material;
heating the dopant material and the porous ceramic body; and
applying an electrical field to diffuse dopant ions into the porous ceramic body.

30. The method according to claim 27, wherein the step of doping a portion of the porous ceramic body comprises ion implantation.

31. The method according to claim 27, wherein the step of doping a portion of the porous ceramic body comprises transmutation.

32. A method of manufacturing a ceramic heating member for an aerosol-generating system, the method comprising:
placing a layer of a first ceramic material in a mold;
placing a layer of a second ceramic material in the mold; and
molding the layer of first ceramic material and the layer of second ceramic material in the mold to form a ceramic heating member comprising a heating portion formed from the layer of first ceramic material and a porous portion formed from the layer of second ceramic material.
